(19) United States
(12) Patent Application Publication
(10) Pub. No.: US 2020/0151119 A1
(43) Pub. Date: May 14, 2020

(54) METHOD AND APPARATUS FOR PERFORMING ACCESS CONTROL BETWEEN HOST DEVICE AND MEMORY DEVICE

(71) Applicant: Silicon Motion, Inc., Hsinchu County (TW)

(72) Inventors: Guo-Rung Huang, Taipei City (TW); Hsing-Lang Huang, Tainan City (TW); Hung-Yueh Lin, Taipei City (TW)

(21) Appl. No.: 16/672,509

(22) Filed: Nov. 3, 2019

Related U.S. Application Data
(60) Provisional application No. 62/757,172, filed on Nov. 8, 2018.

(51) Int. Cl. G06F 13/16; G06F 3/06

(52) U.S. Cl. CPC G06F 13/1668; G06F 3/0679; G06F 3/0659; G06F 3/0622

(57) ABSTRACT

A method for performing access control between a host device and a memory device, an associated bridge device and a bridge controller thereof are provided, where the method is applicable to the bridge device for coupling the memory device to the host device. The method may include: receiving a first test command; returning failure information; receiving a request command; returning device-related information; receiving a second test command; returning pass information; receiving a capacity-related command; reporting a reported logical address (LA) count of the memory device and a reported sector size of the memory device; and performing bi-directional mapping between a memory device side LA format of a set of LAs at the memory device side corresponding to the memory device and a host device side LA format of a set of LAs at the host device side corresponding to the host device during access operation that the host device performs.

### CROSS REFERENCE TO RELATED APPLICATIONS

This application claims the benefit of U.S. Provisional Application No. 62/757,172, which was filed on Nov. 8, 2018, and is included herein by reference.

### BACKGROUND OF THE INVENTION

### 1. Field of the Invention

The present invention is related to memory control, and more particularly, to a method for performing access control between a host device and a memory device such as memory card, etc., and associated apparatus (e.g. a bridge device and a bridge controller thereof).

### 2. Description of the Prior Art

A memory device comprising a Flash memory may be arranged to store data (e.g. user data), and the management of accessing the Flash memory is complicated. For example, the memory device may be a memory card. When a host device (e.g. a multifunctional mobile phone having a Universal Serial Bus (USB) port) is linked to the memory device, errors may occur due to erroneous design of one or more program modules running on the host device, such as a modified version of an open source software solution. More particularly, the modified version may be modified from a common version with bug, and most manufacturers of such host device products may be not aware of the bug or may be not able to treat it. For example, the sector size of the memory device (e.g. the memory card), such as 4 KB (kilobytes), may be different from that of the host device. As a result of the bug, formatting the memory device by the host device may be unsuccessful, and/or existing data in the memory device may become damaged or lost after the host device erroneously changes something of the file system in the memory device, such as exFAT (Extended File Allocation Table). As the related art fails to provide a proper solution for implementing the control mechanism in the host device, a novel method and associated architecture are needed for solving the problems without introducing any side effect or in a way that is less likely to introduce a side effect.

### SUMMARY OF THE INVENTION

It is therefore an objective of the present invention to provide a method for performing access control between a host device and a memory device, and to provide associated apparatus (e.g. a bridge device and a bridge controller thereof), in order to solve the above-mentioned problems.

It is another objective of the present invention to provide a method for performing access control between a host device and a memory device, and to provide associated apparatus (e.g. a bridge device and a bridge controller thereof), in order to protect data in the memory device.

At least one embodiment of the present invention provides a method for performing access control between a host device and a memory device, where the method is applicable to a bridge device for coupling the memory device to the host device. The memory device may comprise a non-volatile (NV) memory, and the NV memory may comprise at least one NV memory element. The method may comprise: receiving a first test command from the host device; in response to the first test command, returning failure information to the host device, wherein the failure information indicates that the bridge device is not ready for serving the host device; receiving a request command from the host device; in response to the request command, returning device-related information to the host device, wherein the device-related information at least indicates existence of the memory device; receiving a second test command from the host device; in response to the second test command, returning pass information to the host device, wherein the pass information indicates that the bridge device is ready for serving the host device; receiving a capacity-related command from the host device; in response to the capacity-related command, reporting a reported logical address (LA) count of the memory device and a reported sector size of the memory device to the host device, wherein the reported LA count is different from a real LA count of the memory device, and the reported sector size is different from a real sector size of the memory device; and performing bi-directional mapping between a memory device side LA format of a set of LAs at the memory device side corresponding to the memory device and a host device side LA format of a set of LAs at the host device side corresponding to the host device during any access operation that the host device performs on the memory device through the bridge device, to allow the host device to access the NV memory in the memory device through the bridge device, wherein the real LA count of the memory device is equal to a number of the set of LAs at the memory device side corresponding to the memory device, and the reported LA count of the memory device is equal to a number of the set of LAs at the host device side corresponding to the host device.

In addition to the above method, the present invention also provides a bridge device, where the bridge device is arranged to perform access control between a host device and a memory device. The memory device may comprise a non-volatile (NV) memory, and the NV memory may comprise at least one NV memory element. The bridge device may comprise a bridge controller, and the bridge controller is arranged to control operations of the bridge device, to allow the host device to access the memory device through the bridge device. For example: the bridge controller receives a first test command from the host device; in response to the first test command, the bridge controller returns failure information to the host device, wherein the failure information indicates that the bridge device is not ready for serving the host device; the bridge controller receives a request command from the host device; in response to the request command, the bridge controller returns device-related information to the host device, wherein the device-related information at least indicates existence of the memory device; the bridge controller receives a second test command from the host device; in response to the second test command, the bridge controller returns pass information to the host device, wherein the pass information indicates that the bridge device is ready for serving the host device; the bridge controller receives a capacity-related command from the host device; in response to the capacity-related command, the bridge controller reports a reported logical address (LA) count of the memory device and a reported sector size of the memory device to the host device, wherein the reported LA count is different from a real LA count of the memory device, and the reported sector size is different from a real sector size of the memory device; and the bridge controller performs bi-directional mapping between a memory device side LA format of a set of LAs at the memory device side corresponding to the memory device and a host device side LA format of a set of LAs at the host device side corresponding to the host device during any access operation that the host device performs on the memory device through the bridge device, to allow the host device to access the NV memory in the memory device through the bridge device, wherein the real LA count of the memory device is equal to a number of the set of LAs at the memory device side corresponding to the memory device, and the reported LA count of the memory device is equal to a number of the set of LAs at the host device side corresponding to the host device.

In addition to the above method, the present invention also provides a bridge controller of a bridge device, where the bridge device comprises the bridge controller, and the bridge controller is arranged to control operations of the bridge device. The bridge device is arranged to perform access control between a host device and a memory device. In addition, the memory device may comprise a non-volatile (NV) memory, and the NV memory may comprise at least one NV memory element. The bridge controller may comprise a processing circuit, and the processing circuit is arranged to control the bridge controller according to a plurality of commands from the host device, to allow the host device to access the memory device through the bridge device. For example: the bridge controller receives a first test command from the host device; in response to the first test command, the bridge controller returns failure information to the host device, wherein the failure information indicates that the bridge device is not ready for serving the host device; the bridge controller receives a request command from the host device; in response to the request command, the bridge controller returns device-related information to the host device, wherein the device-related information at least indicates existence of the memory device; the bridge controller receives a second test command from the host device; in response to the second test command, the bridge controller returns pass information to the host device, wherein the pass information indicates that the bridge device is ready for serving the host device; the bridge controller receives a capacity-related command from the host device; in response to the capacity-related command, the bridge controller reports a reported logical address (LA) count of the memory device and a reported sector size of the memory device to the host device, wherein the reported LA count is different from a real LA count of the memory device, and the reported sector size is different from a real sector size of the memory device; and the bridge controller performs bi-directional mapping between a memory device side LA format of a set of LAs at the memory device side corresponding to the memory device and a host device side LA format of a set of LAs at the host device side corresponding to the host device during any access operation that the host device performs on the memory device through the bridge device, to allow the host device to access the NV memory in the memory device through the bridge device, wherein the real LA count of the memory device is equal to a number of the set of LAs at the memory device side corresponding to the memory device, and the reported LA count of the memory device is equal to a number of the set of LAs at the host device side corresponding to the host device.

The present invention method and associated apparatus can guarantee that the memory device can operate properly in various situations without encountering the related art problems. For example, the method provides multiple control schemes for access control. With aid of the present invention method and associated apparatus, the memory device will not suffer from the existing problems of the related art, such as the unsuccessful formatting problem, the data damage/lost problem, etc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a bridge device according to an embodiment of the present invention.

FIG. 2 illustrates an electronic system according to an embodiment of the present invention, where the electronic system may comprise the bridge device.

FIG. 3 illustrates a write control scheme of a method for performing access control between a host device and a memory device according to an embodiment of the present invention.

FIG. 4 illustrates an example of 4-KB control scheme.

FIG. 5 illustrates a read control scheme of the method according to an embodiment of the present invention.

FIG. 6 illustrates some implementation details of head processing of the read control scheme according to an embodiment of the present invention.

FIG. 7 illustrates some implementation details of tail processing of the read control scheme according to an embodiment of the present invention.

FIG. 8 illustrates a series of interactions between the host device and the bridge device according to an embodiment of the present invention.

FIG. 9 illustrates a working flow of the method for performing access control between the host device and the memory device according to an embodiment of the present invention.

### DETAILED DESCRIPTION

At least one embodiment of the present invention provides a method and apparatus for performing access control between a host device and a memory device. The memory device (e.g. a memory card conforming to a specific communications specification or a Flash storage device) may comprise a memory controller for controlling operations of the memory device, and may further comprise a non-volatile (NV) memory (e.g. a Flash memory) for storing data, where the NV memory may comprise one or more NV memory elements (e.g. one or more Flash memory dies, or one or more Flash memory chips). In addition, a bridge device (e.g. a Universal Serial Bus (USB) bridge device) may be coupled between the host device (e.g. a multifunctional mobile phone, a tablet, etc., having a USB port, for example) and the memory device (e.g. the memory card or the Flash storage device). The bridge device may comprise: a bridge controller, for controlling operations of the bridge device; a slot for installing the memory device at the bridge device; a memory such as a Read-Only Memories (ROM) (e.g. an Electrically-Erasable Programmable Read-Only Memory (EEPROM)) which may be utilized as an external memory of the bridge controller; and one or more connectors. The bridge controller of the bridge device may control the operations of the bridge device according to the method. According to some embodiments, the apparatus may comprise at least one portion (e.g. a portion or all) of the bridge device. For example, the apparatus may comprise the bridge controller within the bridge device. In another example, the apparatus may comprise the bridge device.

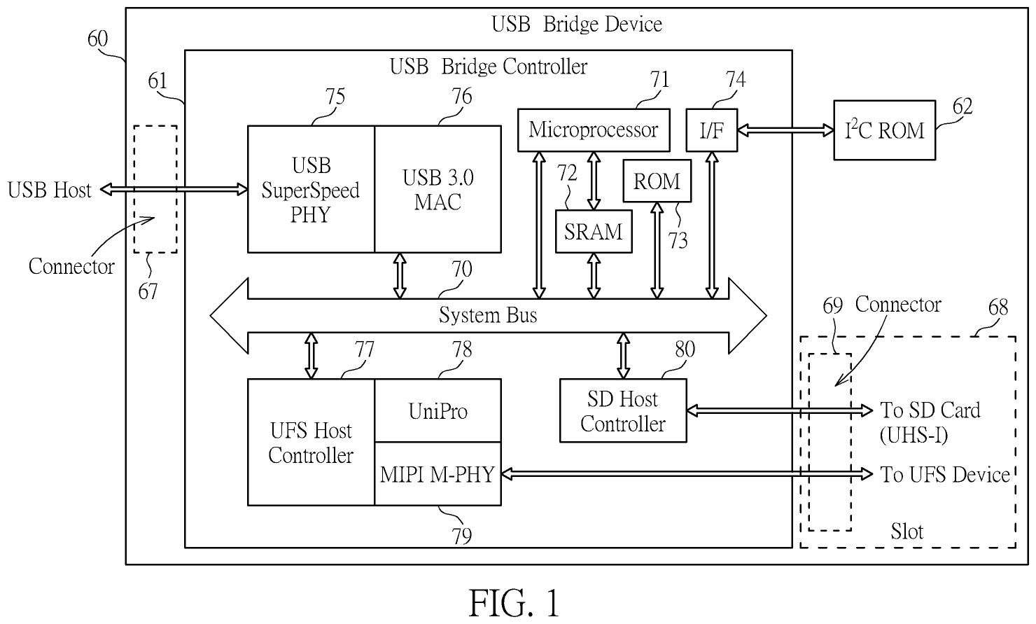

FIG. 1 is a diagram of a bridge device such as a USB bridge device 60 according to an embodiment of the present invention. The bridge device such as the USB bridge device 60 may be coupled between a host device and a memory device. For better comprehension, the host device may be a USB host device (labeled “USB Host” in FIG. 1 for brevity) having a USB port, such as a multifunctional mobile phone, a tablet, etc., and the memory device may be a memory card such as a Secure Digital (SD) card or a Flash storage device such as a Universal Flash Storage (UFS) device, where the SD card may conform to one or more of a set of SD-related specification (e.g. SD specification, SD High Capacity (SDHC) specification, SD eXtended Capacity (SDXC) specification, etc.), and more particularly, may be classified as Ultra High Speed (UHS)-I, and the UFS device may conform to UFS specification, but the present invention is not limited thereto.

As shown in FIG. 1, the USB bridge device 60 may comprise a bridge controller such as a USB bridge controller 61, and may comprise at least one memory such as one or more Inter-Integrated Circuit (I²C)-compatible Read-Only Memories (ROMs), which may be collectively referred to as the I²C ROM 62 (e.g. EEPROM), and may further comprise connectors 67 and 69 and at least one slot such as one or more slots, which may be collectively referred to as the slot 68, and the connector 69 may be integrated into the slot 68. The bridge controller such as the USB bridge controller 61 may comprise a processing circuit such as a microprocessor 71, one or more memories such as a Static Random Access Memory (SRAM) 72 and a ROM 73, an interface (I/F) circuit 74 (labeled “I/F” in FIG. 1, for brevity), one or more physical layer (PHY) circuits such as a USB SuperSpeed PHY circuit 75 and a Mobile Industry Processor Interface (MIPI) M-PHY circuit 79 (respectively labeled “USB SuperSpeed PHY” and “MIPI M-PHY” in FIG. 1, for brevity), one or more associated control circuits such as a USB 3.0 Media Access Control (MAC) circuit 76 (labeled “USB 3.0 MAC” in FIG. 1, for brevity), a UFS host controller 77, and a Unified Protocol (UniPro) circuit 78 (labeled “UniPro” in FIG. 1, for brevity), and a SD host controller 80, and these components may be coupled to each other, for example, through a system bus 70, where the USB SuperSpeed PHY circuit 75 and the MIPI M-PHY circuit 79 may conform to USB specification and MIPI specification, respectively, and the USB 3.0 MAC circuit 76, the UFS host controller 77 and UniPro circuit 78 may conform to USB 3.0 specification, UFS specification, and MIPI UniPro specification, respectively, but the present invention is not limited thereto.

According to this embodiment, the USB bridge controller 61 may be arranged to control operations of the USB bridge device 60. The I²C ROM 62 (e.g. EEPROM) may be utilized as an external memory of the USB bridge controller 61. The connector 67 may be arranged to couple the USB bridge device 60 (more particularly, the USB bridge controller 61) to the host device (e.g. the USB host device). The slot 68 may be arranged to install the memory device (e.g. the SD card or the UFS device) at the USB bridge device 60, and the connector 69 may be arranged to couple the memory device (e.g. the SD card or the UFS device) to the USB bridge device 60 (more particularly, the USB bridge controller 61).

In addition, the processing circuit such as the microprocessor 71 may control operations of the USB bridge controller 61, for example, with aid of at least one set of program code running on the microprocessor 71, in order to control the USB bridge device 60. For example, the aforementioned at least one set of program code may comprise a first set of program code loaded from the ROM 73 and/or a second set of program code loaded from the I²C ROM 62 through the interface circuit 74, but the present invention is not limited thereto. The SRAM 72 may be arranged to store information for the USB bridge device 60 (more particularly, the USB bridge controller 61) when needed.

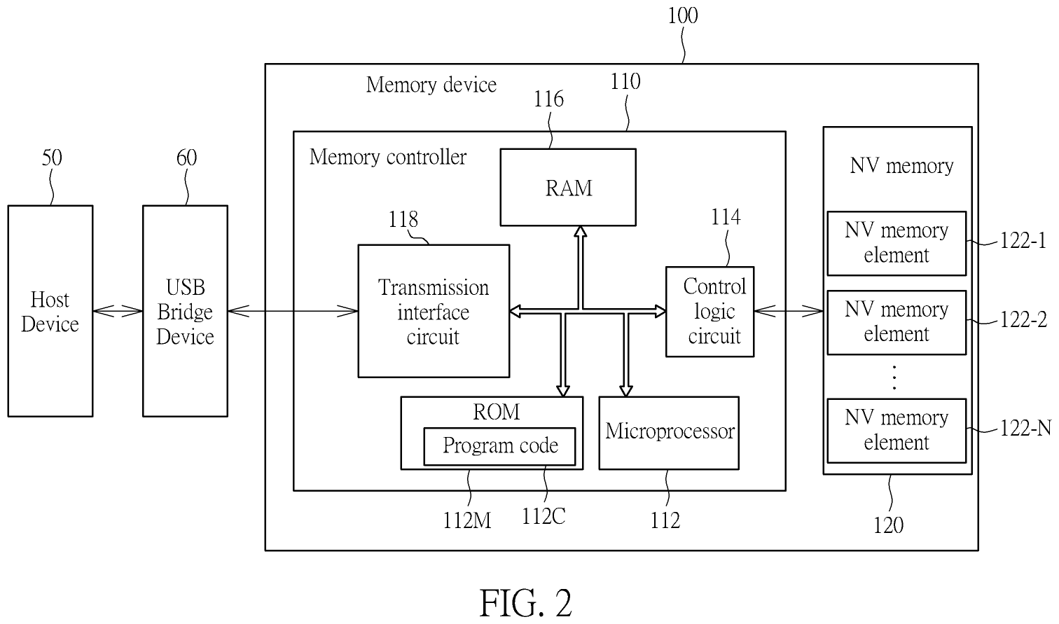

FIG. 2 illustrates an electronic system according to an embodiment of the present invention, where the electronic system may comprise the bridge device such as the USB bridge device 60 shown in FIG. 1, and may further comprise a host device 50 and a memory device 100 which may represent the host device and the memory device mentioned in the embodiment shown in FIG. 1, respectively. The host device 50, the USB bridge device 60, and the memory device 100 may be taken as examples of the host device, the bridge device, and the memory device mentioned above, respectively, and the aforementioned apparatus may comprise at least one portion (e.g. a portion or all) of the USB bridge device 60.

According to this embodiment, the memory device 100 may comprise a memory controller 110 and a non-volatile (NV) memory 120, where the memory controller 110 is arranged to control operations of the memory device 100 and access the NV memory 120, and the NV memory 120 is arranged to store information. The NV memory 120 may comprise at least one NV memory element (e.g. one or more NV memory elements), such as a plurality of NV memory elements 122-1, 122-2, . . . , and 122-N, where “N” may represent a positive integer that is greater than one. For example, the NV memory 120 may be a flash memory, and the plurality of NV memory elements 122-1, 122-2, . . . , and 122-N may be a plurality of flash memory chips or a plurality of flash memory dies, but the present invention is not limited thereto.

As shown in FIG. 2, the memory controller 110 may comprise a processing circuit such as a microprocessor 112, a storage unit such as a ROM 112M, a control logic circuit 114, a RAM 116, and a transmission interface circuit 118, where the above components may be coupled to one another via a bus. The RAM 116 is implemented by an SRAM, but the present invention is not limited thereto. The RAM 116 may be arranged to provide the memory controller 110 with internal storage space. For example, the RAM 116 may be utilized as a buffer memory for buffering data. In addition, the read-only memory 112M of this embodiment is arranged to store a program code 112C, and the microprocessor 112 is arranged to execute the program code 112C to control the access of the NV memory 120 (e.g. Flash memory). Note that, in some examples, the program code 112C may be stored in the RAM 116 or any type of memory. Further, a data protection circuit (not shown) in the control logic circuit 114 may protect data and/or perform error correction, and the transmission interface circuit 118 may conform to a specific communications specification (e.g. UFS specification or SD specification), and may perform communications according to the specific communications specification, for example, perform communications with the USB bridge device 60 for the memory device 100.

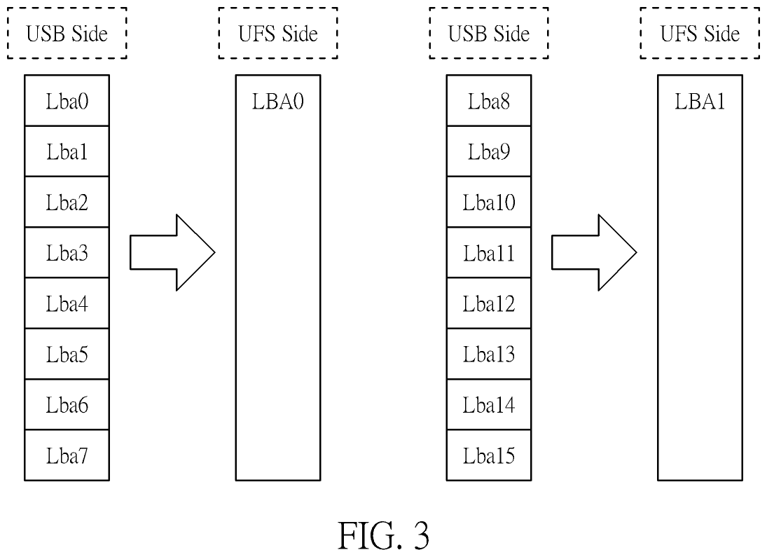

FIG. 3 illustrates a write control scheme of a method for performing access control between a host device and a memory device such as that mentioned above (e.g. the host device 50 and the memory device 100) according to an embodiment of the present invention, where the method may be applied to the architecture shown in FIG. 1 (e.g. the USB bridge device 60 and the USB bridge controller 61) and the electronic system shown in FIG. 2. The USB bridge controller 61 (e.g. the processing circuit such as the microprocessor 71 running the aforementioned at least one set of program code) may control the operations of the USB bridge device 60 according to the method. For example, the aforementioned at least one set of program code (e.g. one or both sets of the first set of program code and the second set of program code that are respectively stored in the ROM 73 and the I²C ROM 62 in advance) may correspond to the method.

Taking the UFS device as an example of the memory device 100, a set of logical addresses (LAs) at the memory device side such as the UFS side (e.g. the LAs {LBA(0), LBA(1), . . . }, which may be written as the LAs {LBA0, LBA1, . . . }, respectively, for brevity) may represent the LAs utilized between the USB bridge controller 61 (e.g. the microprocessor 71 therein) and the memory device 100 (e.g. the UFS device), for the USB bridge device 60 to access the memory device 100 according to this set of LAs, and a set of LAs at the host device side such as the USB side (e.g. the LAs {{Lba(0), Lba(1), Lba(2), Lba(3), Lba(4), Lba(5), Lba(6), Lba(7)}, {Lba(8), Lba(9), Lba(10), Lba(11), Lba(12), Lba(13), Lba(14), Lba(15)}, . . . }, which may be written as the LAs {{Lba0, Lba1, Lba2, Lba3, Lba4, Lba5, Lba6, Lba7}, {Lba8, Lba9, Lba10, Lba1, Lba12, Lba13, Lba14, Lba15}, . . . }, respectively, for brevity) may represent the LAs utilized between the USB bridge controller 61 (e.g. the microprocessor 71 therein) and the host device 50 (e.g. the USB host device), for the host device 50 to access the memory device 100 through the USB bridge device 60 according to this set of LAs, but the present invention is not limited thereto. According to some embodiments, the SD card may be taken as an example of the memory device 100, and the UFS side may be replaced by the SD side.

According to this embodiment, under control of the USB bridge controller 61 (e.g. the processing circuit such as the microprocessor 71 running the aforementioned at least one set of program code), the USB bridge device 60 may perform bi-directional mapping between a memory device side LA format of the set of LAs at the memory device side such as the UFS side (e.g. the LAs {LBA1, LBA1, . . . }) and a host device side LA format of the set of LAs at the host device side such as the USB side (e.g. the LAs {{Lba0, Lba1, Lba2, Lba3, Lba4, Lba5, Lba6, Lba7}, {Lba8, Lba9, Lba10, Lba11, Lba12, Lba13, Lba14, Lba15}, . . . }) during any access operation (e.g. a read operation or a write operation) that the host device 50 performs on the memory device 100 through the USB bridge device 60. For better comprehension, the sector size SIZE_m of the memory device 100 may be 4 KB, and the sector size SIZE_h of the host device 50 may be 0.5 KB, i.e. 512 B (bytes), where the memory device side LA format and the host device side LA format may be the 4-KB format and the 0.5-KB format, respectively, but the present invention is not limited thereto.

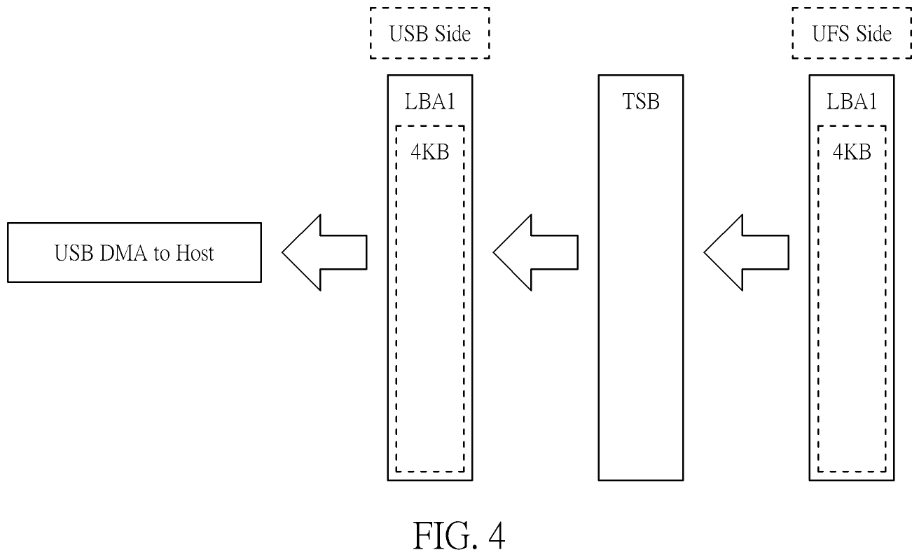

FIG. 4 illustrates an example of a 4-KB control scheme. In this example, the sector size SIZE_m of the memory device side such as the UFS side may be regarded as transparent to the host device side such as the USB side, and may be equal to 4 KB. A bridge device that is implemented according to the 4-KB control scheme does not perform the bi-directional mapping mentioned above, and therefore bypasses all LAs from the host device 50 to the memory device 100 without altering these LAs, where a USB PHY circuit of the bridge device may perform operations of USB direct memory access (DMA) from the bridge device to the host device 50 (labeled “USB DMA to Host” in FIG. 4, for brevity), but the present invention is not limited thereto. For better comprehension, assume that the manufacturer of the host device 50 is not aware of the bug or is not able to treat it, and the bug mentioned above has not been removed from program module(s) running on the host device 50, such as the modified version of the open source software solution. As a result of the bug, the host device 50 may erroneously change something of the file system in the memory device 100, such as exFAT thereof. When a user uses this bridge device, the user may suffer from the existing problems of the related art, such as the unsuccessful formatting problem, the data damage/lost problem, etc., since the erroneous design corresponding to the bug mentioned above typically exists in many host device products on the market.

According to some embodiments, in a situation where a storage device conforming to a certain specification such as the UFS specification (e.g. the Flash storage device such as the UFS device) is positioned at the UFS side, the storage device may access data in an accessing unit of 4 KB, rather than access data in another accessing unit such as 512 B or 1 KB; otherwise, the storage device cannot complete an operation of accessing a set of data such as the data corresponding to the other accessing unit. As a result, changing the accessing unit (e.g. sector size) at the UFS side is not applicable to the storage device. Assuming that the 4-KB control scheme is adopted and the sector size SIZE_m of the memory device side such as the UFS side is transparent to the host device side such as the USB side, the storage device may be not able to get rid of the related art problems due to the bug mentioned above, and therefore these problems remain unsolved.

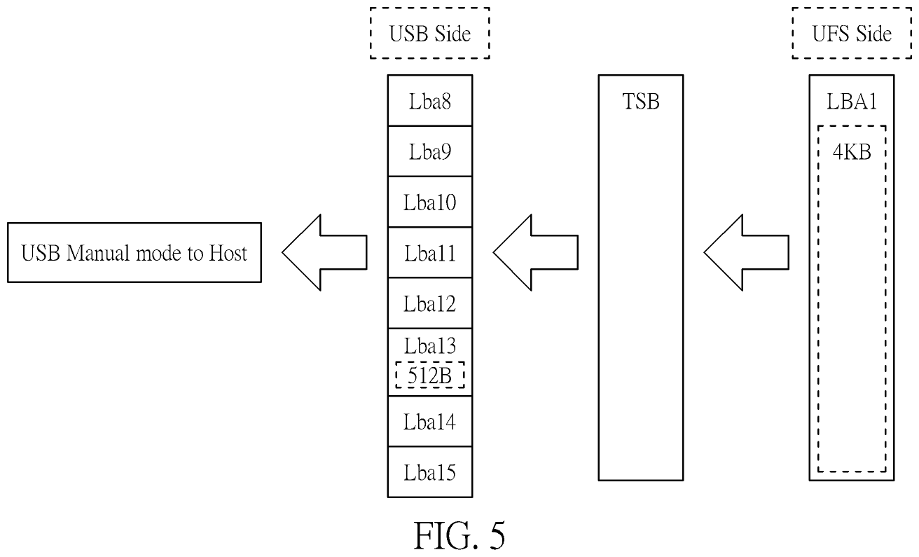

FIG. 5 illustrates a read control scheme of the method according to an embodiment of the present invention. Assume that the host device 50 is going to read target data (e.g. data of 512 B) at the LA Lba13. Based on the mapping relationships of the bi-directional mapping, the USB bridge controller 61 (e.g. the processing circuit such as the microprocessor 71 running the aforementioned at least one set of program code) may control the USB bridge device 60 to read a greater amount of data (e.g. data of 4 KB, labeled “4K” in FIG. 5, for brevity) at the LA LBA1 from the memory device 100, and to extract the target data (e.g. the data of 512 B) from the greater amount of data (e.g. the data of 4 KB), for being read by the host device 50, where the greater amount of data may be temporarily put into the time sharing buffer (TSB) within the SRAM 72, for the microprocessor 71 to extract the target data therefrom. In some examples, the one or more PHY circuits such as the USB SuperSpeed PHY circuit 75 may perform operations of USB manual mode access from the UFS bridge device 60 to the host device 50 (labeled “USB Manual mode to Host” in FIG. 5, for brevity), but the present invention is not limited thereto.

According to this embodiment, under control of the USB bridge controller 61 (e.g. the processing circuit such as the microprocessor 71 running the aforementioned at least one set of program code), the USB bridge device 60 may block the real sector size SIZE_m of the memory device 100 (e.g. 4 KB) to make the real sector size SIZE_m be non-transparent to the host device side such as the USB side, and more particularly, may report a reported sector size SIZE_m_r of the memory device 100 (e.g. 512 B, i.e. 0.5 KB) to the host device 50, and therefore the host device 50 may treat the memory device 100 as if the memory device 100 has the same sector size and the same LA format as that of the host device 50 (e.g. 0.5 KB and the 0.5-KB format), respectively, to skip running the buggy program module(s) corresponding to the bug. For example, SIZE_m_r=SIZE_h.

Please note that the mapping relationships of the bi-directional mapping may comprise at least one mapping relationship between at least one LA at the host device side such as the USB side (e.g. the LA Lba13) and at least one sub-LA within the associated LA at the memory device side such as the UFS side (e.g. one or more sub-LAs corresponding to the LA Lba13 within the LA LBA1, such as that corresponding to the target data). As a result, the host device 50 may access the memory device 100 through the USB bridge device 60 at any LA Lba#Xh of the set of LAs at the host device side such as the USB side (e.g. one of the LAs {{Lba0, Lba1, Lba2, Lba3, Lba4, Lba5, Lba6, Lba7}, {Lba8, Lba9, Lba10, Lba11, Lba12, Lba13, Lba14, Lba15}, . . . }).

According to some embodiments, the USB bridge controller 61 (e.g. the processing circuit such as the microprocessor 71 running the aforementioned at least one set of program code) may map between a LA Lba(Xh) at the host device side such as the USB side (e.g. any LA of the LAs {{Lba(0), Lba(1), Lba(2), Lba(3), Lba(4), Lba(5), Lba(6), Lba(7)}, {Lba(8), Lba(9), Lba(10), Lba(11), Lba(12), Lba(13), Lba(14), Lba(15)}, . . . }, such as any of the LAs {{Lba0, Lba1, Lba2, Lba3, Lba4, Lba5, Lba6, Lba7}, {Lba8, Lba9, Lba10, Lba11, Lba12, Lba13, Lba14, Lba15}, . . . }) and a hybrid LA {LBA(Xm), SLA(Ym)} comprising the associated LA LBA(Xm) and the corresponding sub-LA SLA(Ym) at the memory device side such as the UFS side (e.g. any hybrid LA of the hybrid LAs {{{LBA(0), SLA(0)}, . . . , {LBA(0), SLA(7)}}, {{LBA(1), SLA(0)}, . . . , {LBA(1), SLA(7)}}, . . . }.

The symbol Xh may be an integer falling within the interval [0, (Xh_CNT−1)], and Xh_CNT may represent the total number of available LAs of the memory device 100 at the host device side such as the USB side (e.g. the total number of LAs within the series of LAs {Lba0, Lba1, Lba2, Lba3, Lba4, Lba5, Lba6, Lba7, Lba8, Lba9, Lba10, Lba11, Lba12, Lba13, Lba14, Lba15, . . . }), such as the total number of sectors of the memory device 100 at the host device side such as the USB side. In addition, the symbol Xm may be an integer falling within the interval [0, (Xm_CNT−1)], and Xm_CNT may represent the total number of available LAs of the memory device 100 in the sector level at the memory device side such as the UFS side (e.g. the total number of LAs within the series of LAs {LBA1, LBA1, . . . }), such as the total number of sectors of the memory device 100 at the memory device side such as the UFS side. The symbol Ym may be an integer falling within the interval [0, (Ym_CNT−1)], and Ym_CNT may represent the total number of available sub-LAs of a sector corresponding to the LA LBA(Xm), such as the total number of partial sectors within this sector, where (Xm_CNT*Ym_CNT)=Xh_CNT. For example, assume that S_RATIO represents the ratio (SIZE_m/SIZE_h) of the sector size SIZE_m of the memory device 100 to the sector size SIZE_h of the host device 50, and may be an integer. The symbols Xm and Ym may be expressed as follows:

Xm=(Xh/S RATIO); and

Ym=Xh mod S_RATIO;

where the notation mod may represent the modulo operation. The division operation for obtaining Xm may be integer division such as that in a viewpoint of a programming language (e.g. the C language), but the present invention is not limited thereto. For example, when SIZE_m=4 (KB) and SIZE_h=0.5 (KB), S_RATIO=(SIZE_m/SIZE_h)=8. In this situation, the greater amount of data (e.g. the data of 4 KB, labeled “4K” in FIG. 5) at the LA LBA1 from the memory device 100 may comprise eight sets of sub-data at the sub-LAs {SLA0, SLA1, SLA2, SLA3, SLA4, SLA5, SLA6, SLA7} respectively corresponding to the LAs {Lba8, Lba9, Lba10, Lba11, Lba12, Lba13, Lba14, Lba15}. The USB bridge controller 61 (e.g. the processing circuit such as the microprocessor 71 running the aforementioned at least one set of program code) that is capable of accessing the eight sets of sub-data according to the sub-LAs {SLA0, SLA1, SLA2, SLA3, SLA4, SLA5, SLA6, SLA7} respectively, may extract the target data of the hybrid LA {LBA1, SLA5} (which comprises the LA LBA1 and the sub-LA SLA5) from the eight sets of sub-data according to the sub-LA SLA5.

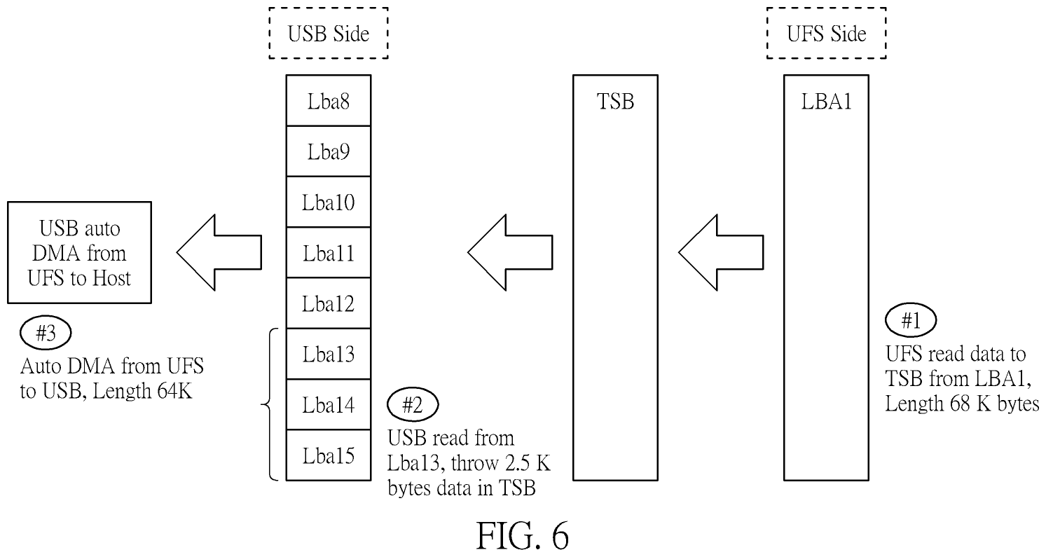

FIG. 6 illustrates some implementation details of head processing of the read control scheme according to an embodiment of the present invention. Assume that the host device 50 is going to read target data (e.g. data of (512*128) B, or (0.5*128) KB, i.e. 64 KB) at the LAs {Lba13, Lba14, Lba15, . . . , Lba140}. Based on the mapping relationships of the bi-directional mapping, the USB bridge controller 61 (e.g. the processing circuit such as the microprocessor 71 running the aforementioned at least one set of program code) may control the USB bridge device 60 to read a greater amount of data (e.g. data of 68 KB) at the LAs {LBA1, . . . , LA17} from the memory device 100, and to extract the target data (e.g. the data of 64 KB) from the greater amount of data (e.g. the data of 68 KB), for being read by the host device 50. For example, in response a request from the USB bridge device 60 for accessing the LAs {LBA1, . . . , LA17}, the memory device 100 may prepare the greater amount of data (e.g. the data of 68 KB), where the greater amount of data starting from the LA LBA1 may be temporarily put into the time sharing buffer (TSB) within the SRAM 72, with the beginning portion (e.g. the data of 4 KB corresponding to the LA LBA1) of the greater amount of data being put in the TSB in Step #1 (labeled “UFS read data to TSB from LBA1, Length 68 K bytes” in FIG. 6, for better comprehension), for the microprocessor 71 to extract the target data therefrom.

During the head processing, under control of the USB bridge controller 61, in Step #2, the USB bridge device 60 may obtain head data (e.g. data of 1.5 KB) corresponding to the LAs {Lba13, Lba14, Lba15} from the first 4-KB data of the greater amount of data (labeled “USB read from Lba13” in FIG. 6, for better comprehension), and may discard other data (e.g. data of 2.5 KB) corresponding to the LAs {Lba8, Lba9, Lba10, Lba11, Lba12} within the first 4-KB data (labeled “throw 2.5 K bytes data in TSB” in FIG. 6, for better comprehension). As a result of triggering one or more automatic DMA operations by the USB bridge controller 61 in Step #3, the host device 50 may read the target data (e.g. the data of 64 KB) starting from the LA Lba13 (labeled “Auto DMA from UFS to USB, Length 64K” in FIG. 6, for better comprehension), but the present invention is not limited thereto. In some examples, the one or more PHY circuits such as the USB SuperSpeed PHY circuit 75 may perform operations of USB automatic DMA from the UFS bridge device 60 to the host device 50 (labeled “USB auto DMA from UFS to Host” in FIG. 6, for brevity), but the present invention is not limited thereto.

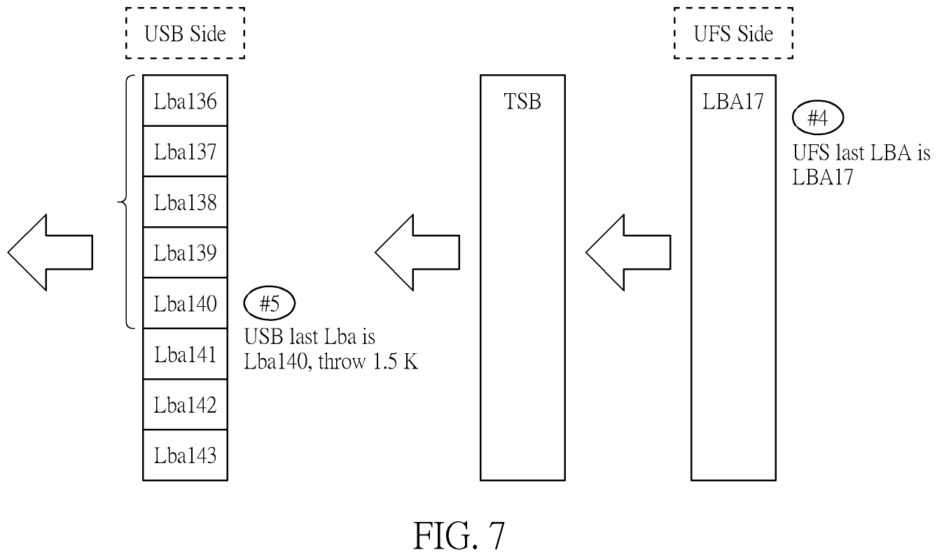

FIG. 7 illustrates some implementation details of tail processing of the read control scheme according to an embodiment of the present invention. For example, in response the request from the USB bridge device 60 for accessing the LAs {LBA1, . . . , LA17}, the memory device 100 may prepare the greater amount of data (e.g. the data of 68 KB), where the greater amount of data starting from the LA LBA1 may be temporarily put into the time sharing buffer (TSB), with the last 4-KB data thereof being read at the LA LA17 in Step #4 (labeled “UFS last LBA is LBA17” in FIG. 6, for better comprehension), for the microprocessor 71 to extract the target data therefrom.

During the tail processing, under control of the USB bridge controller 61, the USB bridge device 60 may obtain tail data (e.g. data of 2.5 KB) corresponding to the LAs {Lba136, Lba137, Lba138, Lba139, Lba140} from the last 4-KB data of the greater amount of data in Step #5 (labeled “USB last Lba is Lba140” in FIG. 7, for better comprehension), and may discard other data (e.g. data of 1.5 KB) corresponding to the LAs {Lba141, Lba142, Lba143} within the last 4-KB data (labeled “throw 1.5 K” in FIG. 7, for better comprehension). As a result of triggering one or more automatic DMA operations by the USB bridge controller 61, the host device 50 may read the target data (e.g. the data of 64 KB) at the LAs {Lba13, . . . , Lba140}, but the present invention is not limited thereto.

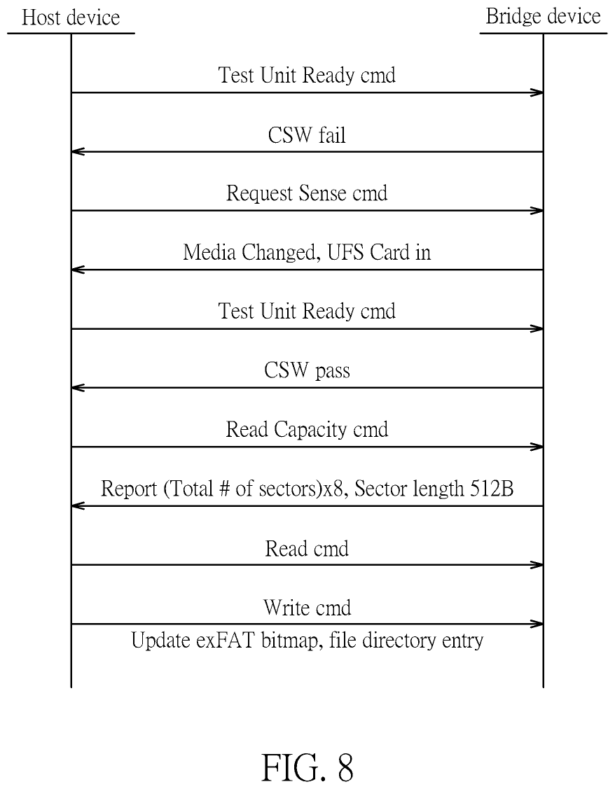

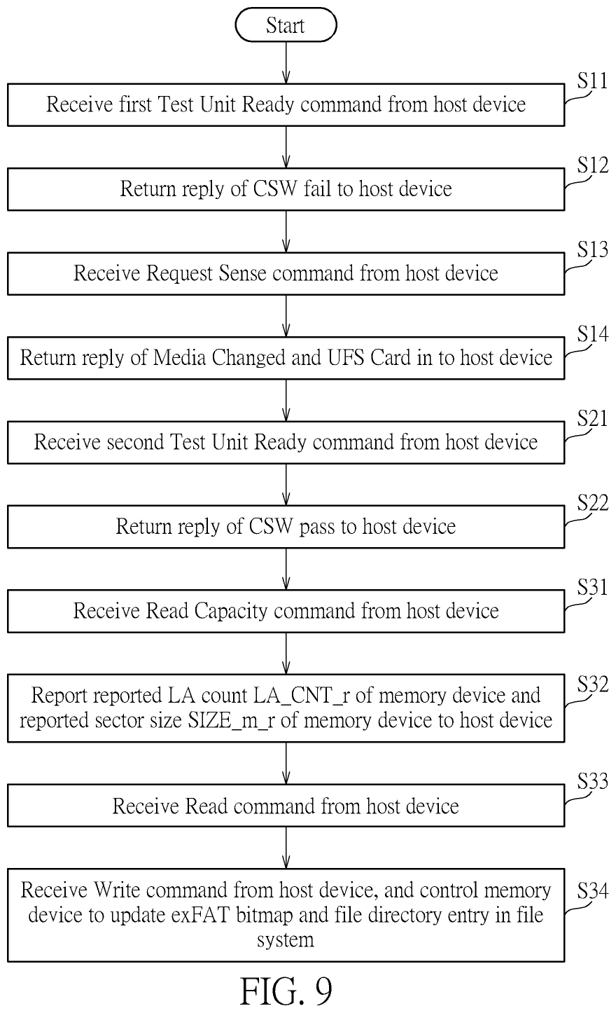

FIG. 8 illustrates a series of interactions between the host device and the bridge device mentioned above, such as the host device 50 shown in FIG. 2 and the USB bridge device 60 shown in any of FIG. 1 and FIG. 2, according to an embodiment of the present invention. For example, under control of the USB bridge controller 61, the USB bridge device 60 may operate as illustrated in FIG. 8 according to a working flow of the method as shown in FIG. 9. For better comprehension, the USB bridge device 60 may conform to Small Computer System Interface (SCSI) specification, and may send status information in the Command Status Wrapper (CSW) to the host device 50, but the present invention is not limited thereto.

In Step S11, as the host device 50 may send a first Test Unit Ready command (labeled “Test Unit Ready cmd” at the first rightward arrow in FIG. 8, for brevity) to the USB bridge device 60, the USB bridge device 60 (e.g. the USB bridge controller 61) may receive the first Test Unit Ready command from the host device 50.

In Step S12, in response to the first Test Unit Ready command, the USB bridge device 60 (e.g. the USB bridge controller 61) may return a reply of CSW fail to the host device 50.

In Step S13, as the host device 50 may send a Request Sense command (labeled “Request Sense cmd” in FIG. 8, for brevity) to the USB bridge device 60, the USB bridge device 60 (e.g. the USB bridge controller 61) may receive the Request Sense command from the host device 50.

In Step S14, in response to the Request Sense command, the USB bridge device 60 (e.g. the USB bridge controller 61) may return a reply of Media Changed and UFS Card in (labeled “Media Changed, UFS Card in” in FIG. 8, for brevity) to the host device 50, for example, in a situation where the memory device 100 such as the UFS device (e.g. a UFS card) has been inserted into the slot 68.

In Step S21, as the host device 50 may send a second Test Unit Ready command (labeled “Test Unit Ready cmd” at the third rightward arrow in FIG. 8, for brevity) to the USB bridge device 60, the USB bridge device 60 (e.g. the USB bridge controller 61) may receive the second Test Unit Ready command from the host device 50.

In Step S22, in response to the second Test Unit Ready command, the USB bridge device 60 (e.g. the USB bridge controller 61) may return a reply of CSW pass to the host device 50.

In Step S31, as the host device 50 may send a Read Capacity command (labeled “Read Capacity cmd” in FIG. 8, for brevity) to the USB bridge device 60, the USB bridge device 60 (e.g. the USB bridge controller 61) may receive the Read Capacity command from the host device 50.

In Step S32, in response to the Read Capacity command, the USB bridge device 60 (e.g. the USB bridge controller 61) may report a reported LA count LA_CNT_r of the memory device 100 (e.g. LA_CNT_r=(Xm_CNT*S_RATIO)) and the reported sector size SIZE_m_r of the memory device 100 (e.g. 512 B, i.e. 0.5 KB) to the host device 50 (labeled “Report (Total # of sectors)×8, Sector length 512B” in FIG. 8, for better comprehension, where “Total # of sectors” may stand for the total number of sectors at the memory device side such as the UFS side, e.g. Xm_CNT, and “×8” may stand for multiplying by S_RATIO with S_RATIO=8, for example). According to this embodiment, the reported LA count LA_CNT_r of the memory device 100 may represent a reported number of sectors, and may be equal to the total number of sectors at the memory device side (e.g. Xm_CNT) multiplied by S_RATIO. For example, the reported number of sectors (e.g. “(Total # of sectors)×8” in FIG. 8) may be equal to the total number of sectors (e.g. “Total # of sectors” in FIG. 8) multiplied by S_RATIO with S_RATIO=8.

In Step S33, as the host device 50 may send a Read command (labeled “Read cmd” in FIG. 8, for brevity) to the USB bridge device 60, the USB bridge device 60 (e.g. the USB bridge controller 61) may receive the Read command from the host device 50. For example, in response to the Read command, the USB bridge device 60 may read data (e.g. the target data in one or more of the above embodiments) based on the mapping relationships of the bi-directional mapping.

In Step S34, as the host device 50 may send a Write command (labeled “Write cmd” in FIG. 8, for brevity) to the USB bridge device 60, and may send a request for updating an exFAT bitmap and file directory entry in the file system (labeled “Update exFAT bitmap, file directory entry” in FIG. 8, for brevity), the USB bridge device 60 (e.g. the USB bridge controller 61) may receive the Write command from the host device 50, and may control the memory device 100 to update the exFAT bitmap and file directory entry in the file system.

For better comprehension, the method may be illustrated with the working flow shown in FIG. 9, but the present invention is not limited thereto. According to some embodiments, one or more steps may be added, deleted, or changed in the working flow shown in FIG. 9.

According to this embodiment, under control of the USB bridge controller 61 (e.g. the processing circuit such as the microprocessor 71 running the aforementioned at least one set of program code), the USB bridge device 60 may report the reported LA count LA_CNT_r and the reported sector size SIZE_m_r of the memory device 100 to the host device 50, and therefore the host device 50 may treat the memory device 100 as if the memory device 100 has the same sector size and the same LA format as that of the host device 50 (e.g. 0.5 KB and the 0.5-KB format), respectively, to skip running the buggy program module(s) corresponding to the bug. For brevity, similar descriptions for this embodiment are not repeated in detail here.

According to some embodiments, under control of the bridge controller such as the USB bridge controller 61, the bridge device such as the USB bridge device 60 is arranged to perform access control between the host device 50 and the memory device 100. The bridge controller such as the USB bridge controller 61 is arranged to control operations of the bridge device such as the USB bridge device 60, to allow the host device 50 to access the memory device 100 through the bridge device. For example, the USB bridge device 60 receives a first test command from the host device 50; in response to the first test command, the USB bridge device 60 returns failure information to the host device 50, wherein the failure information may indicate that the USB bridge device 60 is not ready for serving the host device 50; the USB bridge device 60 receives a request command from the host device 50; in response to the request command, the USB bridge device 60 returns device-related information to the host device 50, wherein the device-related information at least indicates existence of the memory device 100, and more particularly, may indicate that the memory device 100 has been installed at the USB bridge device 60; the USB bridge device 60 receives a second test command from the host device 50; in response to the second test command, the USB bridge device 60 returns pass information to the host device 50, wherein the pass information may indicate that the USB bridge device 60 is ready for serving the host device 50, and more particularly, may indicate that the USB bridge device 60 at which the memory device 100 has been installed is ready for serving the host device 50; the USB bridge device 60 receives a capacity-related command from the host device 50; in response to the capacity-related command, the USB bridge device 60 reports a reported logical address (LA) count of the memory device 100 and a reported sector size of the memory device 100 to the host device 50, wherein the reported LA count is different from a real LA count of the memory device 100, and the reported sector size is different from a real sector size of the memory device 100; and the USB bridge device 60 performs bi-directional mapping between a memory device side LA format of a set of LAs at the memory device side corresponding to the memory device 100 and a host device side LA format of a set of LAs at the host device 50 side corresponding to the host device 50 during any access operation that the host device 50 performs on the memory device 100 through the USB bridge device 60, to allow the host device 50 to access the NV memory 120 in the memory device 100 through the USB bridge device 60, wherein the real LA count of the memory device 100 is equal to a number of the set of LAs at the memory device side corresponding to the memory device 100, and the reported LA count of the memory device 100 is equal to a number of the set of LAs at the host device 50 side corresponding to the host device 50. For brevity, similar descriptions for these embodiments are not repeated in detail here.

According to some embodiments, each of the first test command and the second test command is a Test Unit Ready command (e.g. the first Test Unit Ready command and the second Test Unit Ready command mentioned in Step S11 and Step S21, respectively). For example, the failure information comprises a reply of CSW fail (e.g. the reply of CSW fail as mentioned in Step S12), and the pass information comprises a reply of CSW pass (e.g. the reply of CSW pass as mentioned in Step S22). In addition, the request command is a Request Sense command (e.g. the Request Sense command mentioned in Step S13), and the capacity-related command is a Read Capacity command (e.g. the Read Capacity command mentioned in Step S31). For example, the device-related information comprises information indicating that storage media is changed. In another example, the device-related information comprises information indicating that a UFS device is utilized as the memory device 100. For brevity, similar descriptions for these embodiments are not repeated in detail here.

According to some embodiments, the reported LA count of the memory device 100 is a multiple of the real LA count of the memory device 100. For example, the reported LA count of the memory device 100 is eight times the real LA count of the memory device 100. In addition, the real sector size of the memory device 100 is a multiple of the reported sector size of the memory device 100. For example, the real sector size of the memory device 100 is eight times the reported sector size of the memory device 100. More particularly, the reported sector size of the memory device 100 is equal to 512 bytes, and the real sector size of the memory device 100 is equal to 4096 bytes (or 4 KB). For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing access control between a host device and a memory device, the method being applicable to a bridge device for coupling the memory device to the host device, the memory device comprising a non-volatile (NV) memory, the NV memory comprising at least one NV memory element, the method comprising:
receiving a first test command from the host device;
in response to the first test command, returning failure information to the host device, wherein the failure information indicates that the bridge device is not ready for serving the host device;
receiving a request command from the host device;
in response to the request command, returning device-related information to the host device, wherein the device-related information at least indicates existence of the memory device;
receiving a second test command from the host device;
in response to the second test command, returning pass information to the host device, wherein the pass information indicates that the bridge device is ready for serving the host device;
receiving a capacity-related command from the host device;
in response to the capacity-related command, reporting a reported logical address (LA) count of the memory device and a reported sector size of the memory device to the host device, wherein the reported LA count is different from a real LA count of the memory device, and the reported sector size is different from a real sector size of the memory device; and
performing bi-directional mapping between a memory device side LA format of a set of LAs at the memory device side corresponding to the memory device and a host device side LA format of a set of LAs at the host device side corresponding to the host device during any access operation that the host device performs on the memory device through the bridge device, to allow the host device to access the NV memory in the memory device through the bridge device, wherein the real LA count of the memory device is equal to a number of the set of LAs at the memory device side corresponding to the memory device, and the reported LA count of the memory device is equal to a number of the set of LAs at the host device side corresponding to the host device.

2. The method of claim 1, wherein each of the first test command and the second test command is a Test Unit Ready command, the request command is a Request Sense command, and the capacity-related command is a Read Capacity command.

3. The method of claim 1, wherein each of the first test command and the second test command is a Test Unit Ready command, the failure information comprises a reply of Command Status Wrapper (CSW) fail, and the pass information comprises a reply of CSW pass.

4. The method of claim 1, wherein the request command is a Request Sense command, and the device-related information comprises information indicating that storage media is changed.

5. The method of claim 1, wherein the request command is a Request Sense command, and the device-related information comprises information indicating that a Universal Flash Storage (UFS) device is utilized as the memory device.

6. The method of claim 1, wherein the reported LA count of the memory device is a multiple of the real LA count of the memory device.

7. The method of claim 6, wherein the reported LA count of the memory device is eight times the real LA count of the memory device.

8. The method of claim 1, wherein the real sector size of the memory device is a multiple of the reported sector size of the memory device.

9. The method of claim 8, wherein the real sector size of the memory device is eight times the reported sector size of the memory device.

10. The method of claim 8, wherein the reported sector size of the memory device is equal to 512 bytes, and the real sector size of the memory device is equal to 4096 bytes.

11. A bridge device, arranged to perform access control between a host device and a memory device, the memory device comprising a non-volatile (NV) memory, the NV memory comprising at least one NV memory element, the bridge device comprising:
a bridge controller, arranged to control operations of the bridge device, to allow the host device to access the memory device through the bridge device, wherein:
the bridge controller receives a first test command from the host device;
in response to the first test command, the bridge controller returns failure information to the host device, wherein the failure information indicates that the bridge device is not ready for serving the host device;
the bridge controller receives a request command from the host device;
in response to the request command, the bridge controller returns device-related information to the host device, wherein the device-related information at least indicates existence of the memory device;
the bridge controller receives a second test command from the host device;
in response to the second test command, the bridge controller returns pass information to the host device, wherein the pass information indicates that the bridge device is ready for serving the host device;
the bridge controller receives a capacity-related command from the host device;
in response to the capacity-related command, the bridge controller reports a reported logical address (LA) count of the memory device and a reported sector size of the memory device to the host device, wherein the reported LA count is different from a real LA count of the memory device, and the reported sector size is different from a real sector size of the memory device; and
the bridge controller performs bi-directional mapping between a memory device side LA format of a set of LAs at the memory device side corresponding to the memory device and a host device side LA format of a set of LAs at the host device side corresponding to the host device during any access operation that the host device performs on the memory device through the bridge device, to allow the host device to access the NV memory in the memory device through the bridge device, wherein the real LA count of the memory device is equal to a number of the set of LAs at the memory device side corresponding to the memory device, and the reported LA count of the memory device is equal to a number of the set of LAs at the host device side corresponding to the host device.

12. The bridge device of claim 11, wherein each of the first test command and the second test command is a Test Unit Ready command, the request command is a Request Sense command, and the capacity-related command is a Read Capacity command.

13. The bridge device of claim 11, wherein each of the first test command and the second test command is a Test Unit Ready command, the failure information comprises a reply of Command Status Wrapper (CSW) fail, and the pass information comprises a reply of CSW pass.

14. The bridge device of claim 11, wherein the request command is a Request Sense command, and the device-related information comprises information indicating that storage media is changed.

15. The bridge device of claim 11, wherein the request command is a Request Sense command, and the device-related information comprises information indicating that a Universal Flash Storage (UFS) device is utilized as the memory device.

16. A bridge controller of a bridge device, the bridge device comprising the bridge controller arranged to control operations of the bridge device, the bridge device being arranged to perform access control between a host device and a memory device, the memory device comprising a non-volatile (NV) memory, the NV memory comprising at least one NV memory element, the bridge controller comprising:
a processing circuit, arranged to control the bridge controller according to a plurality of commands from the host device, to allow the host device to access the memory device through the bridge device, wherein:
the bridge controller receives a first test command from the host device;
in response to the first test command, the bridge controller returns failure information to the host device, wherein the failure information indicates that the bridge device is not ready for serving the host device;
the bridge controller receives a request command from the host device;
in response to the request command, the bridge controller returns device-related information to the host device, wherein the device-related information at least indicates existence of the memory device;
the bridge controller receives a second test command from the host device;
in response to the second test command, the bridge controller returns pass information to the host device, wherein the pass information indicates that the bridge device is ready for serving the host device;
the bridge controller receives a capacity-related command from the host device;
in response to the capacity-related command, the bridge controller reports a reported logical address (LA) count of the memory device and a reported sector size of the memory device to the host device, wherein the reported LA count is different from a real LA count of the memory device, and the reported sector size is different from a real sector size of the memory device; and
the bridge controller performs bi-directional mapping between a memory device side LA format of a set of LAs at the memory device side corresponding to the memory device and a host device side LA format of a set of LAs at the host device side corresponding to the host device during any access operation that the host device performs on the memory device through the bridge device, to allow the host device to access the NV memory in the memory device through the bridge device, wherein the real LA count of the memory device is equal to a number of the set of LAs at the memory device side corresponding to the memory device, and the reported LA count of the memory device is equal to a number of the set of LAs at the host device side corresponding to the host device.

17. The bridge controller of claim 16, wherein each of the first test command and the second test command is a Test Unit Ready command, the request command is a Request Sense command, and the capacity-related command is a Read Capacity command.

18. The bridge controller of claim 16, wherein each of the first test command and the second test command is a Test Unit Ready command, the failure information comprises a reply of Command Status Wrapper (CSW) fail, and the pass information comprises a reply of CSW pass.

19. The bridge controller of claim 16, wherein the request command is a Request Sense command, and the device-related information comprises information indicating that storage media is changed.

20. The bridge controller of claim 16, wherein the request command is a Request Sense command, and the device-related information comprises information indicating that a Universal Flash Storage (UFS) device is utilized as the memory device.
